(19) United States
(12) Patent Application Publication
(10) Pub. No.: US 2024/0093990 A1
(43) Pub. Date: Mar. 21, 2024

(54) METHOD AND APPARATUS FOR RIVERBED MONITORING USING A FIBER OPTIC CABLE SENSOR

(71) Applicant: John Michael Lynk, Houston, TX (US)

(72) Inventor: John Michael Lynk, Houston, TX (US)

(21) Appl. No.: 18/460,560

(22) Filed: Sep. 3, 2023

Related U.S. Application Data
(60) Provisional application No. 63/376,286, filed on Sep. 19, 2022.

(51) Int. Cl. G01C 13/00

(52) U.S. Cl. CPC G01C 13/002

(57) ABSTRACT

This specification describes a sensing device that is permanently installed in a riverbed to monitor sediment scour and deposition levels to provide information regarding hazards to infrastructure or ecological systems. The sensor is oblong and composed of fiber optic cables and other materials such that the sensor body is held orthogonal to the riverbed/river water interface and can be interrogated continuously or periodically to provide information on the spatial position of the riverbed/river water interface. The sensor is more accurate than existing options because it simultaneously senses the physical condition of fiber optic cable where it is buried in static sediment, and where it is exposed to moving river water. Intrinsic interrogative sensing is performed on the fiber optic cable or cables for strain, temperature, or acoustic vibration conditions, or combinations thereof. Methods for fabrication, installation, and use of the sensor are also described and claimed.

### FIELD

The general field of this invention is equipment for sensing and measuring earth conditions, that is installed in a resident fashion. Other different inventions in this general field include slope inclinometers, piezometers, groundwater monitoring wells, wholly buried fiber optic cables, water level meters, and many other devices. In the field of fiber optic sensing, this invention utilizes intrinsic fiber optic sensing.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this present section should be read in this light, and not necessarily as admissions of prior art.

This invention pertains to the endeavor of monitoring riverbed sediment scour and deposition to prevent damage to valuable infrastructure and ecological systems. Described plainly, when rivers flood, they cause sediment from their riverbeds to be scoured away. When the removal of riverbed sediment occurs, infrastructure can be damaged, which is not desired in most cases. For example, a pipeline can be exposed and then damaged by debris carried by the river, or the sand holding up a bridge pier can be washed away, letting gravity destroy the bridge pier and bridge. The present invention is a resident oblong sensor installed orthogonally to the riverbed that can continually or sporadically be interrogated to provide information on how much riverbed scour, or restorative sedimentation, has occurred. The part of the sensor that is exposed to moving river water communicates dynamic strain, temperature, or acoustic information. The part of the sensor that is buried in sediment communicates signals that tend to be less dynamic, and the difference between the two signal return types is interpreted to indicate where the riverbed sediment level is. This is done by means of fiber optic cable interrogation.

Fiber optic cables are flexible glass cables that enable the passage of light, light refraction, light photon scatter, and the total internal reflection of light. As photons of light travel down a fiber optic cable, many of them are reflected when they arrive at the edge of the cable, and then continue to traverse down the cable, until the next time they arrive at the edge of the cable and are reflected again.

A fiber-Bragg grating is a structure created within a fiber optic cable that changes the index of refraction of the fiber optic cable in a certain space, often at multiple nearby locations. These structures cause light photons to be refracted and reflected differently than they are in unaltered fiber optic cable, and change the frequency of the light that passes through the grating. Temperature changes and acoustic noise can also cause light photons to scatter and experience frequency changes. Raleigh, Raman, and Brilliouin scatter are types of photon scatter that can be interrogated.

For the purposes of this invention, it is critical to understand that a fiber optic cable can be stimulated with light, that light may be distorted throughout its journey down the cable both by Bragg gratings at known distances or by external impulses such as strain, acoustic noise, and temperature change, and the distorted frequency of light returns to the stimulus point via total internal reflection, and can be interrogated. Through advanced physics and math, the location, type, and magnitude of external impulse on the fiber optic cable can be calculated. This general method of using fiber optic cable itself to sense impulses (as opposed to using it to be a conduit between a sensor and a user interface) is known as intrinsic sensing. The general method of using the entire length of the fiber optic cable for intrinsic sensing is known as distributed sensing.

To summarize, for the purpose of this invention, it is important to know that fiber optic cable can be used for distributed intrinsic sensing, in order to detect the type, location, and magnitude of impulses. These impulses include strain induced by physical stress, strain induced by temperature changes, and acoustic noise.

This invention relies on the physical mechanisms of fiber optic cable distributed intrinsic sensing with the ultimate goal of preventing hazards to valuable infrastructure created by river scour. River scour is a phenomenon where riverbed sediment is entrained into the moving water column of a river, which allows dynamic water flow where there was once relatively static sediment.

River scour can be harmful to valuable infrastructure in a number of ways. For examples, if a fluid-bearing pipeline buried beneath a river becomes exposed to the moving water current, it could be struck by current-borne debris and be damaged or break. Or, the pipeline would likely begin vibrating in the water via vortex induced vibration, and could experience a fatigue failure. Pertinent to the highway and rail transportation industries, the sediment supporting bridge piers can and has been scoured away in some instances, leading to bridge foundation and superstructure failures. Other kinds of polygonal structures that could be impacted negatively by river scour include dams, piers, docks, ports, buildings, and other structures. Other kinds of linear infrastructure that could be impacted negatively by river scour include electric power cables, telecommunication cables, tunnels, and other linear infrastructure.

Also of note, this invention could be used by personnel interested in knowing river sedimentation and scour levels for natural ecological processes. For example, it could be useful to have information on upstream scour levels to know if downstream fish spawning beds or waterfowl feeding areas could be negatively impacted by scoured and re-deposited silt.

The fluvial dynamics of how rivers periodically scour sediment and periodically deposit sediment can cause challenges for developing a full or informed understanding of what level of threat river scour actually poses to infrastructure. One confounding phenomenon is that often, the highest scour risk to an infrastructure element occurs during a flood, when river flow and velocity is highest. These events are often contemporaneous with rainstorms, thunderstorms, tornados, or associated flooding, all of which typically increase safety hazards to humans that might want to measure riverbed scour condition during the flood. As such, technologies that would have to be actively deployed in or above the river during a storm are unsafe to launch and realistically unable to gather information during high-scour events. Resident sensors offer some distinct safety advantage over actively-deployed sensors during high-scour events.

Another confounding phenomenon is that although rivers often create scouring at or near valuable infrastructure, they also very often re-deposit other sediment at the scoured location from upstream. So while an element of valuable infrastructure may be at high risk during a time-constrained flooding and scouring event, by the next day or the next week it may have returned to a low-risk state. There are some distinct advantages to resident sensors that can detect changes continuously, and not just indicate whether or not a threshold event has been reached.

To summarize the background of this invention, there is an ardent need to monitor river scour conditions for both valuable infrastructure elements and for wildlife ecological purposes. Resident sensors offer certain advantages to sensing river scour conditions, as do sensors that can monitor conditions along a gradient continuously, rather than only indicate whether or not a threshold event has been achieved. Intrinsic, or intrinsic distributed fiber optic sensing is a physical technique that can provide information about physical impulses caused by stress or strain, temperature, vibration, and acoustic noise. This invention utilizes intrinsic or intrinsic distributed fiber optic sensing to monitor river scour conditions. This invention monitors a natural earth condition, where that natural earth condition may have an impact on infrastructure or ecological systems.

### SUMMARY OF THE INVENTION

This invention utilizes intrinsic fiber optic sensing to monitor river scour conditions. It is generally comprised of an elongated sensor body that has a fiber optic cable or cables embedded within it. In a preferred embodiment, it also has a central tube that provides the passage of fluid, to assist with installation processes.

The sensor is installed in a riverbed such that a vector component of the elongate sensor body is orthoganol to the riverbed sediment/river water column interface. In a preferred embodiment, the sensor is installed independent of other structures. However, in certain embodiments it may installed dependent upon an infrastructure element, such as being bound to a bridge pier of concern. This can in some cases increase the value of the information obtained, or make installation easier.

A single sensor or a field of sensors may be deployed to monitor a given area.

In a preferred embodiment, the bodies of the sensor are installed by means of a drill rig positioned on a barge that advances a borehole in the riverbed. One manner of executing this is by advancing a sacrificial non-threaded bit with anti-rotational grooves, cutting teeth, and jet nozzles to the base of a steel casing, and then advancing the casing to a desired depth by a combination of downwards pressure, rotation, jetting, or vibration. When the casing is advanced to the desired depth, it is “overdrilled” to a greater depth to accommodate for potential sediment influx upon withdrawal of the casing. Once the overdepth drilling is complete, the casing is jarred to induce separation of the sacrificial bit, and retracted.

At that point, the casing box is separated from drill sub, and a tape measure with a plumb bob is dropped down the casing to measure the depth of the riverbed sediment column. This is compared to the driller's log to determine how deep the sediment-free hole is. If it is satisfactory, the sensor body is installed in the casing. Water may also be jetted down the casing or through the center tube of the sensor, in a preferred embodiment, to seat the sensor at the desired depth. Once the sensor is seated, the drill sub is stabbed into the casing, and retracted, leaving the sensor behind to be enveloped by riverbed sediment, with its uppermost end exposed to the moving column of river water.

Once the sensor is installed in the riverbed, human divers are deployed to peel back the sensor communication arm and connect it to the sensor fiber optic communication cables, which are connected to the fiber optic interrogation outlet. The communication arm and riverbed segment of the sensor fiber optic communication cable are buried in the riverbed by means of digging or jetting, or are weighted to keep them submerged.

In an alternative embodiment, a horizontal directional drill creates a borehole from the riverbank into the riverbed, and the sensor is installed from a barge floating in the river water, and then retracted into the borehole by the horizontal directional drill string. In this embodiment, the fiber optic cable communication legs are continuous with the fiber optic cable sensing legs, without a direction change within the sensor body.

Either during installation by means of a driller's log and surveying equipment, or after installation, the spatial position of the sensor is recorded. This allows sediment depth thresholds to be calculated and set relative to valuable infrastructure, or specified ecological target limits. The angle relative to vertical of the sensor body is also recorded. It is of note that the sensor body need not be vertical, but a vector element of it has to be orthogonal to the interface of the riverbed and river water.

Interrogation of the fiber optic cable or cables takes place at the fiber optic interrogation outlet, which is just a solid housing for the free end of the fiber optic cable or cables where an interrogation unit can be connected. Interrogation units can be resident, but then have to be powered on-site. Interrogation units can also be non-resident, and brought to site periodically by a technician. Interrogation for fiber optic cable strain, temperature changes, or acoustic noise is performed by using established interpretations of light backscatter or frequency return.

Redundancy of fiber optic cables within a single sensor is a preferred embodiment of the present invention. Fiber optic cables are made of somewhat brittle glass and could be broken such that redundant cables would permit uninterrupted sensing. Also, different cables within one sensor can be interrogated simultaneously for different impulses, to provide a richer data set.

Similarly, redundancy of sensors within a riverbed is a preferred embodiment of the present innovation. Multiple sensors in one area provides a fuller picture of where sediment is being scoured from and deposited to. Also, multiple sensors provide redundancy in case a single sensor becomes useless.

The primary purpose of these sensors is to routinely determine where the riverbed is relative to valuable infrastructure. A secondary purpose is to determine scour and sedimentation patterns for ecological concerns.

### BRIEF DESCRIPTION OF THE DRAWINGS

So that the present inventions can be better understood, certain drawings are appended hereto. It is to be noted, however, that the drawings illustrate only selected embodiments of the inventions and are therefore not to be considered limiting of scope, for the inventions may admit to other equally effective embodiments and applications.

FIG. 1A shows a plan view of a river and riverbanks, comprised of water and soil. There is a linear infrastructure element buried beneath the riverbed from the left side to the right side of the drawing, and a rectangular infrastructure element, a building, towards the right side of the drawing. Also depicted is the invention, with sensor bodies shown as small circles in the river water, fiber optic communication cables extending from the river water to the riverbanks, and fiber optic interrogation outlets on the riverbanks.

FIG. 1B is a section view of the river and riverbanks shown in FIG. 1A. FIG. 2 is the same drawing as FIG. 1B, but at a larger magnification for easier viewing and labeling. In the section view, the linear infrastructure element arcs underneath the river in a curved profile. The rectangular infrastructure element, the building, is shown towards the right side of the drawing, with its foundation embedded in the riverbank soil. The sensor bodies of the present invention are illustrated as vertical or near-vertical elements, mostly buried in the riverbed soil but with their tops exposed to the river water. Sensor fiber optic communication cables extend from near the tops of the sensor bodies, buried in the riverbank soil, and connect to the fiber optic interrogation outlets higher on the riverbanks. Also depicted on the left side of the drawing is a human technician, carrying a portable interrogation unit.

FIGS. 3A, 3B, and 3C are top and side isometric views of the sensor bodies, in various sensing and deployment configurations.

FIG. 3A shows the sensor body in the configuration it would be at upon completion of manufacturing, during shipping, and just prior to installation, with the communication arm not yet peeled back, and no sensing arms peeled back from the sensor body.

FIG. 3B shows the sensor body in a primary sensing configuration, with the communication arm peeled back and attached to a fiber optic cable union, but no sensing arms peeled back. Sensing can still occur in this configuration.

FIG. 3C shows the sensor body in an alternate sensing configuration, with the communication arm and multiple sensing arms peeled back.

FIGS. 4A, 4B, and 4C are detailed top isometric views of the sensor. They are the same as the views shown in FIGS. 3A, 3B, and 3C, respectively, but magnified for easier viewing in labeling. The components of each sensor are described further in the detailed description, below.

### DETAILED DESCRIPTION OF CERTAIN EMBODIMENTS

### Definitions

As used herein, the term:

“river” refers to a river, stream, bayou, estuary, or other elongate body of moving water bound by terrestrial borders;

“fluvial” refers to something of or relating to a river;

“riparian” refers to the geographic region between the natural high-water flood levees of a river;

“riverbed” refers to the sediment beneath the moving water of a river;

“riverbank” refers to the sediment not beneath water in a riparian corridor;

“riparian fluid” refers to the air or water in a riparian corridor;

“sediment” refers to clay, silt, sand, gravel, cobble, boulders, organic solids, or other solid matter comprising the solid portion soil;

“scour” refers to the removal of sediment from a riverbed by means of water friction entraining sediment grains, grain-to-grain saltation, or other natural processes;

“deposition” refers to the addition of sediment to a riverbed by means of sediment grains falling out of suspension in river water;

“fiber optic cable” refers to an elongate strand of optical material that allows the passage of light and internal reflection and refraction of light;

“interrogation” is the process of sending a light signal down a fiber optic cable and receiving a distorted signal back from which interpretations regarding the physical condition of the cable can be interpreted;

“infrastructure” refers to man-made structures such as pipelines, telecommunication structures, bridges, roadways, or buildings;

“threshold level” or “threshold event” refer to a pre-defined state in a riverbed when either undesirable sediment scour or undesirable sediment deposition has created an increased risk of damage to valuable infrastructure or an ecological system, and a response action may be triggered;

“casing” refers to cylindrical steel pipe used in geotechnical drilling applications with one concave internally threaded box end and one convex externally threaded pin end;

“drill sub” or “saver sub” refers to a short section of casing connected to a drill rig rotary drive on its box end and multiple different casings below, on its pin end;

“stab” refers to the process of positioning a threaded casing pin inside a threaded casing box for the purpose of rotational attachment;

### DESCRIPTION OF SELECTED SPECIFIC EMBODIMENTS

The inventions are described herein in connection with certain specific embodiments. However, to the extent that the following detailed description is specific to a particular embodiment or a particular use, such is intended to be illustrative only and is not to be construed as limiting the scope of the inventions.

For decades or longer, weather or nature-related damage to infrastructure has been treated as unpredictable “force majeure” events, or “acts of God”. With advances in meteorology, geology, mathematics, computing, and other sciences, the technical community has come to the conclusion that weather acts in somewhat predictable patterns, and weather or nature-related damage incidents can be predicted or detected with some advance warning, and in many cases prevented because of that advance warning.

The present inventions can be considered advances in geology and sensing to provide advance warning of pending nature-related damage to infrastructure, such that the damage may be prevented by other actions. Typical other actions could include depositing cobble or other sediment on the riverbed, evacuating a building that could be damaged, or reducing pressure on a pipeline that could be damaged.

It is important to note in the present invention that the sensor is designed to sense conditions about nature, which then impacts infrastructure or ecological systems. The sensor is installed at a known location in space relative to the infrastructure, and then acts to indicate where the riverbed/river water interface is. As the riverbed sediment is scoured or deposited, the sensor can be interrogated to indicate that the risk to infrastructure has increased because riverbed sediment has scoured away, or that risk has decreased because more riverbed sediment has been deposited.

As an overview, in one aspect, the present invention comprises a flexible rod. It can sense where a moving river current is making it move, and sense where a static riverbed is holding it still, simultaneously. This flexible rod sensor can be interrogated to indicate where it is moving or stationary, and the location of that interface interpreted to be the elevation of the river water/riverbed interface. If that interface gets too close to valuable infrastructure, a user of the present invention is informed of increased hazard, and can act appropriately to protect the valuable infrastructure. (Alternatively, changes in the sediment level can inform a user of other hazards, such as ecological hazards to spawning fish.)

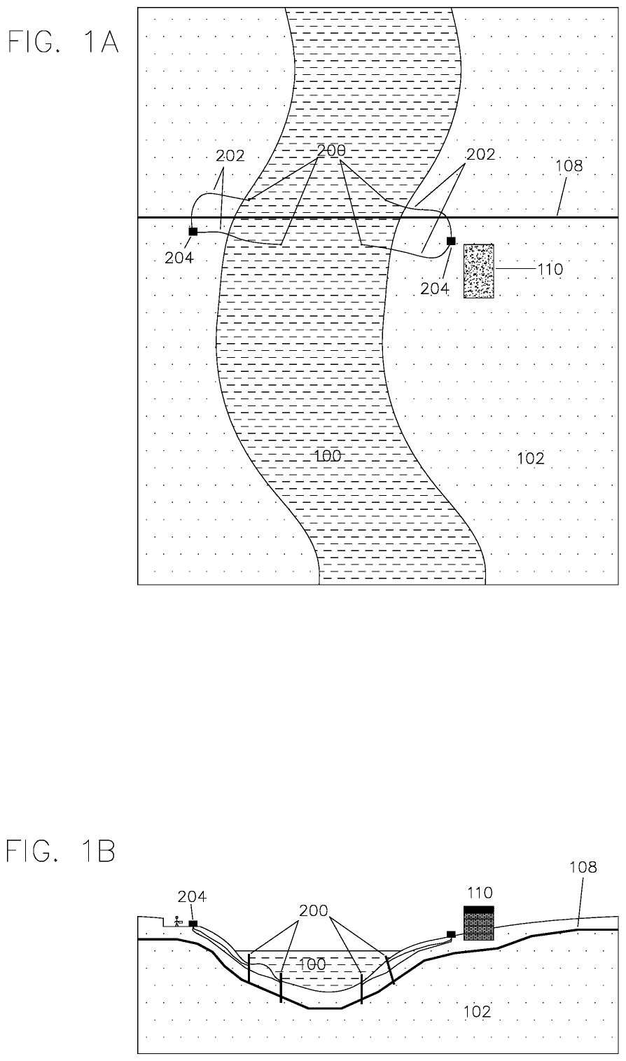

FIGS. 1A, 1B, and 2A depict a river 100 with a meandering shape that passes through soil 102. The soil comprises both the riverbed 104 and the riverbank 106. The riverbanks 106, riverbed 104, and river 100 form a riparian corridor.

Generally, meandering rivers change paths towards their outside bends, so in FIG. 1A, it could be expected that over time, the river channel would migrate towards the left, and potentially expose the valuable linear infrastructure element 108 to the column of moving water 100. This could expose that valuable linear infrastructure element to vortex-induced vibration and eventual fatigue failure, or impact blows from sediment carried by the river.

Another failure mechanism is cutoff avulsion, whereby a river changes course dramatically during a flood to a less energy-intensive path. In this depiction, a likely scenario could be an avulsive new river channel formed where the valuable polygonal infrastructure element 110, a building, is located.

In FIGS. 1A, 1B, and 1C, the sensor bodies 200 are installed vertically or near-vertically in the riverbed 104 sediment. By means of fiber optic interrogation, they indicate where they are strained, vibrating, where there is temperature change, where there is acoustic change, or combinations thereof. The detection of a relatively static strain signal where the sensor 200 is embedded in the riverbed soil 104 provides contrast to the relatively dynamic strain signal where the sensor 200 is exposed to the moving river water 100. The interpretation of where the signal changes from static to dynamic indicates the approximate elevation of the interface of the riverbed sediment 104 and the river water 100.

Interrogation of the sensor bodies 200 is performed at the fiber optic interrogation outlets, 204. In the depicted embodiment, a human technician interrogates the sensors with a portable fiber optic interrogation unit 206. In alternative embodiments, the interrogation unit 206 may be resident with the fiber optic interrogation outlet 204. During interrogation, light is transmitted from the fiber optic interrogation outlets 204, through the sensor fiber optic communication cables 202, into the sensor bodies 200, and then reflected back through the communication cables 202, into the interrogation outlets 204, and into the interrogation unit 206.

The fiber optic interrogation unit 206 may store the interrogation data locally. It may additionally transmit the interrogation data, and any interpretations it makes of it, to other computers by means of telecommunication or internet signals. These interpretations may be incorporated with a geographic information system, and may also inform pre-determined threshold levels that create an action item for an end user. For example, if a storm event causes an increase in the current of the river water 100 which causes an increase in scour of the riverbed sediment 104, and the geographic elevation of the riverbed 104 is lowered by three feet, the sensor body 200 will show dynamic strain signals over its entire length, and when the sensor body 200 is interrogated with the fiber optic interrogation unit 206, it may automatically send signals using telecommunication methods to a computer with a geographic information system with pre-determined thresholds that then send an electronic message to an end user requiring them to inspect the site or remediate it by depositing cobble where the river scour is occurring.

It is of note that unlike other sensors, the present invention sensor bodies 200 need no adjustment after a threshold event. They are designed to remain resident when scour events occur and provide information on the severity of the scour events, and to remain resident and provide information when deposition events occur. Similarly, the sensor fiber optic communication cables are designed to be buried at sufficient depth or with sufficient weight that they do not require modification to continue providing information following a scour or deposition event.

Also of note, the fiber optic interrogation outlets 204 are designed to be emplaced high enough on the riverbank 106 that they can be safely interrogated with the fiber optic interrogation unit 206 during flood events, during which scouring hazard is typically highest.

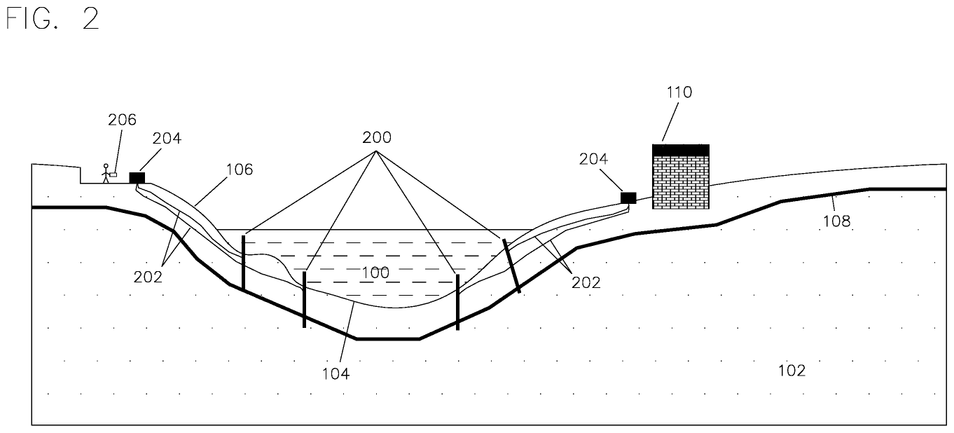

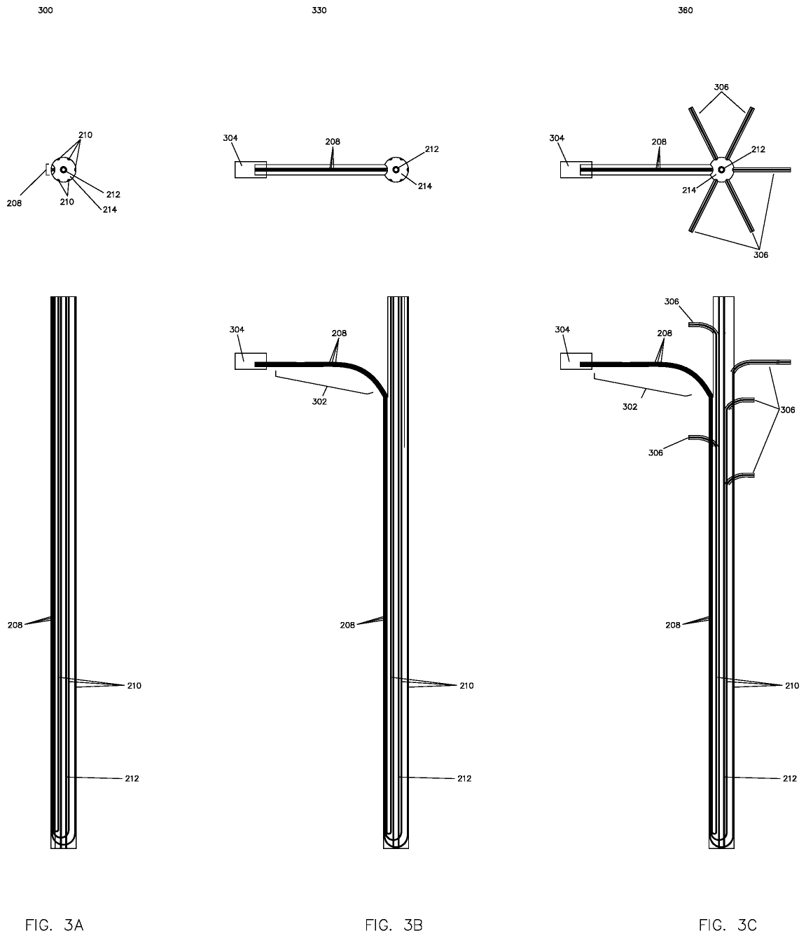

FIG. 3A shows sensor body 300 in isometric top and side views. On the right side of both views are the sensing legs of the fiber optic cables themselves. Of note, in the pictured embodiment there are multiple fiber optic cables; here, five. Although alternate embodiments of the invention include only one fiber optic cable per sensor body, multiple fiber optic cables can provide redundancy in the case of breakage, confirmation of signal change, and ability to better sense at different elevations, as is shown in FIG. 3C.

Also in FIGS. 3A, 3B, and 3C, there is center tube 212. This tube is not present in all embodiments, but in a preferred embodiment it provides enough rigidity for the sensor body to stand roughly erect, with a vector component orthogonal to the river water 100/riverbed 104 interface, but with enough flexibility to enable motion for that part of the senor body 200 exposed to the moving water column 100. In the present embodiment, the center tube 212 is hollow, which enables water to be jetted through it to aid in installation. In other embodiments, the center tube 212 may actually be a solid rod. Further, the center tube need not be a rigid material such as metal or plastic, but is in some embodiments a soft-core buoyant material, to use buoyancy to achieve the same orthogonality requirements as rigidity.

Complementary to the center tube 212 is the sensor body elastomer 214. The sensor body elastomer 214 has many functions, among them, to protect the fiber optic cable sensing legs 210 and fiber optic cable communication legs 208 from breaking due to impact or abrasion, to provide ample rigidity and flexibility to the sensor body, and in some embodiments to provide a desired buoyancy to the sensor body 200.

It is of note that a preferred embodiment of the sensor is shown in the drawings, and that there are many other embodiments of the present inventions. For example, in the depicted embodiments, the sensor body elastomer would most likely be formed by injection molding liquid polymer around the center tube 212, as well as the fiber optic cable sensing legs 210, fiber optic cable communication legs 208, and laminar separations for sensor arms 216.

In an alternative and much simpler embodiment still described by the present inventions, multiple independent fiber optic cable sensing legs 210 could be covered with separate sensor body elastomer 214 that is extruded onto each fiber optic cable sensing leg. These would then be connected to a center tube 212 comprised of either a solid metal bar or a plastic tube, or both. In a simple embodiment, multiple fiber optic sensing cables 212 of varying lengths could be secured to a polyvinyl chloride tube and a piece of steel reinforcing bar with flexible linear fasteners. This would be advanced downwards into the riverbed soil 104, in some instances adjacent to a bridge pier, by means of jetting water through the sensor tube 212 as well as striking it with a hammer. The fiber optic cable communication legs 208 are not submerged in water in that embodiment, but are exposed to the air and affixed to the non-submerged portion of the bridge pier, and connected to a fiber optic interrogation outlet 204 on the bridge deck or adjacent roadway.

The actual sensing components of the sensor body 200 are the fiber optic cable sensing legs 210, which are connected to the fiber optic cable communication legs 208. The fiber optic cable sensing legs 208 produce different frequencies of reflected light when interrogated for changes in strain, temperature, or vibration. As depicted in FIG. 3A, the fiber optic cable sensing legs 210 are integral with the fiber optic communication legs 208, by means of bending the fiber optic cable as shown at the bottom of the side view.

FIG. 3B shows sensor body 330 in isometric top and side views. This is a sensing configuration, with communication arm 302 peeled back from the sensor body 200, and a fiber optic cable union 304 attached. Although the multiple fiber optic cable sensing legs 210 are all in a vertical position aligned with the sensor body 200, they are still configured to sense fluvial conditions.

FIG. 3C shows sensor body 360 in isometric top and side views. As with sensor body 330, sensor body 360 has the communication arm 302 peeled back from the sensor body 200, and a fiber optic cable union 304 attached. Unlike sensor body 330, sensor body 360 also has splayed fiber optic sensing arms 306 peeled back from sensor body 200. In this embodiment, the fiber optic sensing arms 306 have greater surface area that could be exposed to a river water column 100, which could provide more contrast to a condition when a sensing arm 306 is embedded in riverbed soil 102.

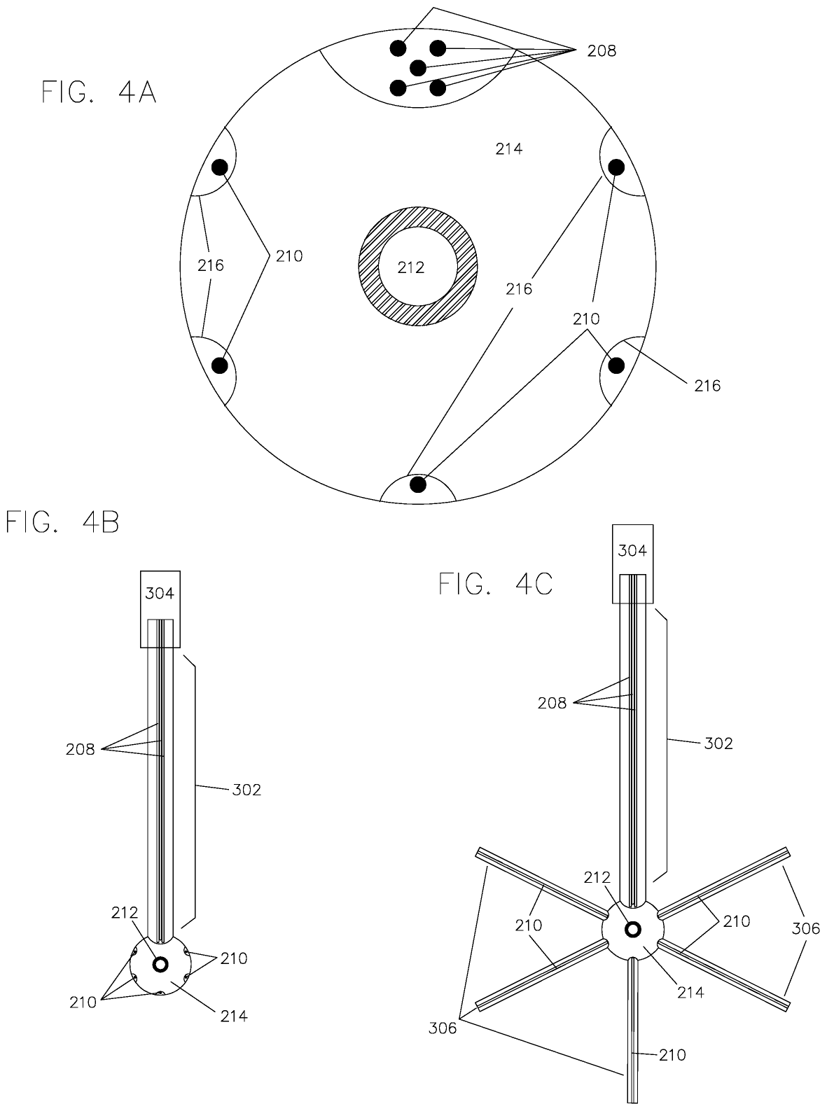

FIG. 4A, FIG. 4B, and FIG. 4C are detailed isometric top views of the sensor.

FIG. 4A shows the isometric top view of the sensor body in its shipping/installation position. Center tube 212 is shown in the center of the figure. Fiber optic cable communication legs 208 are shown embedded in the communication arm 302, which has not been peeled back from the sensor body elastomer 214 of the sensor body 200. The communication arm 302 is separated from the sensor body elastomer 214 by a laminar separation for sensor arms 216. The laminar separation for sensor arms 216 is comprised of a mechanical separator to prevent injection-molded elastomer comprising the sensor arms 216 from combining with elastomer comprising the sensor body 200 during manufacturing. With adequate laminar separation, the communication arm 302 can be peeled back from sensor body 200 during installation to enable the communication arm 302 to be buried in riverbed sediment, leading back to the riverbank and fiber optic interrogation outlet 204.

Similarly, fiber optic cable sensing legs 210 are also separated from sensor body 200, and the sensor body elastomer 214 it is comprised of, by laminar separation for sensor arms 216, such that they can be also peeled back to form splayed fiber optic sensing arms 306 as shown in FIG. 4C.

FIG. 4B and FIG. 4C both show the sensor with communication arm 302 peeled back, and affixed to fiber optic cable union 304. Fiber optic cable union 304 is used to connect to sensor fiber optic communication cable 202.

FIG. 4C shows splayed fiber optic sensing arms 306 peeled back from the sensor body 200 and the sensor body elastomer 214 it is comprised of.

The present invention is a novel elongate fiber-optic sensor used to continuously monitor riverbed scour and sedimentation, permanently installed in a riverbed with a vector element orthogonal to the riverbed/river water interface. The sensor can sense a variety of conditions, such as axial strain, vibration, acoustic noise, and temperature changes, and takes advantage of the very clear signal differences between fiber optic cable buried in relatively static sediment, and fiber optic cable surrounded by moving river water. This is advantageous and novel, to have physical contact with a static soil body, and physical signals from that; and to have physical contact with a moving water body, and the physical signals from that, simultaneously. As such, a signal as pronounced and simple to interrogate as axial strain can provide extremely clear and accurate interpretations of where the riverbed sediment/river water interface is.

Further, the present invention is specifically designed to sense the spatial position of the sediment/water interface of a riverbed, and has an effective range proportional to the sensor body length, which can simultaneously sense the condition of the relatively static riverbed sediment and the relatively dynamic moving river water. Also, the permanent nature of the resident sensor disclosed herein, combined with its axial length in a riverbed and water column, advantageously enables it to sense continuously; before, during, and after major sediment scour and deposition events, without alteration or re-setting of the sensor. Similarly, the present invention is interrogated either remotely or from a spatially high location in the riparian corridor, which contributes to user safety and equipment integrity, and enables data capture during hazardous flooding scour events.

1. A resident fiber optic sensor that utilizes intrinsic sensing to sense one or more fluvial conditions.

2. The apparatus of claim 1, in which the sensor body is installed in a riverbed independent of a valuable infrastructure element
or structurally dependent upon it.

3. The apparatus of claim 2 that is installed with a vector element of the sensor body orthogonal to the riverbed sediment/river water column interface, such that the spatial range of sediment scour or deposition that can be sensed is proportional to the sensor body length.

4. The apparatus of claim 3 that is installed with a portion of the sensor body embedded within riverbed sediment and a portion of the sensor body exposed to a column of moving river water.

5. The apparatus of claim 4 that is installed with the extent of the sensor body terminating within the riparian corridor of the riverbed being sensed.

6. The apparatus of claim 5 wherein the sensor body is installed in a riverbed, but the sensor interrogation unit that is connected to the sensor body via continuous fiber optic cable is installed at a distance from the sensor such that it is safer or more convenient to interrogate than it would be closer to the sensor body.

7. The apparatus of claim 6 wherein the sensor may be interrogated either
on site by a technician manually interrogating the sensor; or
remotely by means of a resident sensor with telecommunications-enabled data transmission.

8. The apparatus of claim 7 that may be installed
singly
or in an array of multiple sensors.

9. A method of sensing a dynamically moving water column and a relatively static body of sediment simultaneously with one sensor.

10. The method of claim 9, wherein intrinsic fiber optic sensing is utilized.

11. The method of claim 10, wherein one or multiple fiber optic cables are interrogated for external force strain, temperature-based strain, vibration, or acoustic noise, or combinations thereof.

12. The method of claim 11, wherein readings from multiple fiber optic cables within one sensor may be compared to draw conclusions regarding riverbed sediment scour or deposition.

13. The method of claim 11, wherein readings from multiple different sensor bodies may be compared to draw conclusions regarding riverbed sediment scour or deposition.

14. The method of claim 11, wherein fiber optic interrogation may be performed with
a remote interrogation unit that is not permanently connected to the sensor,
or with a resident interrogation unit permanently connected to the sensor.

15. The method of claim 11, wherein a permanently connected interrogation unit is connected to an internet- or telecommunications-enabled signal transmitter.

16. The method of claim 14, where riverbed sediment changes are transmitted via internet or other telecommunications to a geographic information systems.

17. The method of claim 14, where threshold river scour or sedimentation events and associated user alerts are incorporated into the geographic information system.

18. The method of claim 9, wherein the contrast between the dynamic water column signals and relatively static sediment signals are used to determine a riverbed position.

19. The method of claim 9, wherein changes in the position of a riverbed may be monitored continuously over time, without modification to the installation of the sensor.

20. The method of claim 9, wherein riverbed sensing may be applied sporadically or continuously.
